(19) United States
(12) Patent Application Publication
(10) Pub. No.: US 2025/0312979 A1
(43) Pub. Date: Oct. 9, 2025

(54) Additively Manufactured Inserts for Composite Materials

(71) Applicant: UWM Research Foundation, Inc., Milwaukee, WI (US)

(72) Inventors: Patrick M. Severson, De Pere, WI (US); Rani El Hajjar, Milwaukee, WI (US)

(21) Appl. No.: 19/169,696

(22) Filed: Apr. 3, 2025

Related U.S. Application Data
(60) Provisional application No. 63/575,198, filed on Apr. 5, 2024.

(51) Int. Cl. B29C 70/68; B29C 70/70; B33Y 10/00; B33Y 80/00

(52) U.S. Cl. CPC B29C 70/682; B29C 70/70; B33Y 80/00; B33Y 10/00

(57) ABSTRACT

An insert for a composite material includes a support column, a first flange secured to a first end of the support column, a second flange secured to a second, opposite end of the support column, one or more chambers circumferentially arranged around the support column, one or more walls extending from the first flange to the second flange defining the one or more chambers, and a channel extending from an input opening in the first flange to the one or more chambers. The channel guides potting material from the input opening into the one or more chambers.

### CROSS-REFERENCE TO RELATED APPLICATIONS

This application claims the benefit of U.S. Provisional Application No. 63/575,198, filed Apr. 5, 2024, which is hereby incorporated by reference in its entirety.

### BACKGROUND

Sandwich composites (e.g., sandwich panels) typically include a core and one or more face sheets. In some examples, the panels include metallic inserts arranged through the panels to permit mounting of the panels (e.g., to a structure or other mounting location). However, current metallic inserts (e.g., potted inserts) may be prone to failure due to a lack of adhesion to the panels. Further, current metallic inserts may require additional machining, such as the drilling of holes in the insert, after a panel cure process, which may be undesirable.

Similarly, solid laminates, which typically include multiple plies of fiber-reinforced materials without a core, face comparable challenges when integrating fasteners (e.g., mechanical fasteners). For example, drilling into the solid laminates can cause significant damage to the laminate (e.g., fiber breakage, free-edge delamination, entry and exit delamination, free-, matrix cracking, thermal degradation, etc.), which may reduce the static strength and diminish the fatigue life compared to the laminate material.

### SUMMARY

According to one aspect of the present disclosure, an insert for a composite material can include a support column. A first flange can be secured to a first end of the support column. A second flange can be secured to a second, opposite end of the support column. One or more chambers can be circumferentially arranged around the support column. One or more walls can extend from the first flange to the second flange, the one or more walls defining the one or more chambers. A channel can extend from an input opening in the first flange to the one or more chambers, the channel to guide potting material from the input opening into the one or more chambers.

In some examples, the insert can be formed via an additive manufacturing process.

In some examples, the first flange and the second flange can be at least partially overlapped by respective first and second face sheets of a sandwich panel.

In some examples, the one or more walls can extend from the support column to an edge of the first flange and an edge of the second flange.

In some examples, the channel can be formed within the insert during the additive manufacturing process.

In some examples, the insert can be sandwiched between the first and second face sheets of the sandwich panel.

In some examples, the one or more walls can each define an aperture to permit the flow of potting material between the one or more chambers.

According to another aspect of the present disclosure, a method of manufacturing a sandwich panel can include arranging an insert within an aperture of a core of a sandwich panel. The method can include sandwiching the insert between a first face sheet of the sandwich panel and a second face sheet of the sandwich panel, the first face sheet arranged on a first side of the core and the second face sheet arranged on a second, opposite side of the core. The method can include curing the sandwich panel after sandwiching the insert between the first face sheet and the second face sheet. The method can include injecting potting material into the insert after the curing the sandwich panel.

In some examples, the potting material can be injected into one or more chambers of the insert via a J-shaped channel.

In some examples, the insert can be formed via an additive manufacturing process.

In some examples, the J-shaped channel can be formed within the insert during the additive manufacturing process.

In some examples, the method can include sandwiching the insert between the first face sheet and the second face sheet so that the first face sheet partially overlaps a first flange of the insert, and the second face sheet partially overlaps a second flange of the insert.

In some examples, the one or more chambers can be defined by one or more walls, and potting material can flow between the one or more chambers via an aperture defined by each of the one or more walls.

According to yet another aspect of the present disclosure, an insert for a composite material can include a support column having a first end and a second end. A first flange can be secured to the first end of the support column. A second flange can be secured to the second end of the support column. A plurality of chambers can be arranged circumferentially around the support column between the first flange and the second flange. A plurality of walls can extend from the support column, between the first flange and the second flange, to define the chambers. An input channel can extend from an input opening in the first flange to at least one of the chambers, the input channel configured to guide potting material from the input opening into the chambers.

In some examples, the insert can be formed via an additive manufacturing process.

In some examples, the first flange and the second flange can be at least partially overlapped by respective first and second face sheets of a sandwich panel.

In some examples, the walls can each define an aperture to permit the flow of potting material between the chambers.

In some examples, the walls can each define a cutout to permit the flow of potting material between the chambers.

In some examples, the insert can include a thru-hole extending through the first flange, the support column, and the second flange, the thru-hole to receive a fastener.

In some examples, the insert can include an output channel extending from an output opening in the first flange to at least one of the chambers, the output channel configured to guide potting material from the chambers out of the output opening.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a cross-sectional partial view of a panel including an insert according to aspects of the present disclosure.

FIG. 2 is an axonometric view of the insert of FIG. 1.

FIG. 3 is a top view of the insert of FIG. 2.

FIG. 4 is a bottom view of the insert of FIG. 2.

FIG. 5 is a side view of the insert of FIG. 2.

FIG. 6 is a cross-sectional view of the insert of FIG. 2.

FIG. 7 is another cross-sectional view of the insert of FIG. 2.

FIG. 8 is yet another cross-sectional view of the insert of FIG. 2.

FIG. 9 is a flowchart illustrating a manufacturing process of the panel of FIG. 1 including the insert of FIG. 2.

FIG. 10 is an axonometric view of another example of a panel including an insert according to aspects of the present disclosure.

FIG. 11 is an axonometric view of the panel and the insert of FIG. 10, with a thru-hole drilled through the insert.

FIG. 12 is an axonometric view of the insert of FIG. 10.

FIG. 13 is a cross-sectional view of the insert of FIG. 12.

FIG. 14 is an axonometric view of the insert of FIG. 12 with the thru-hole drilled.

FIG. 15 is a flowchart illustrating a manufacturing process of the panel of FIG. 10 including the insert of FIG. 12.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

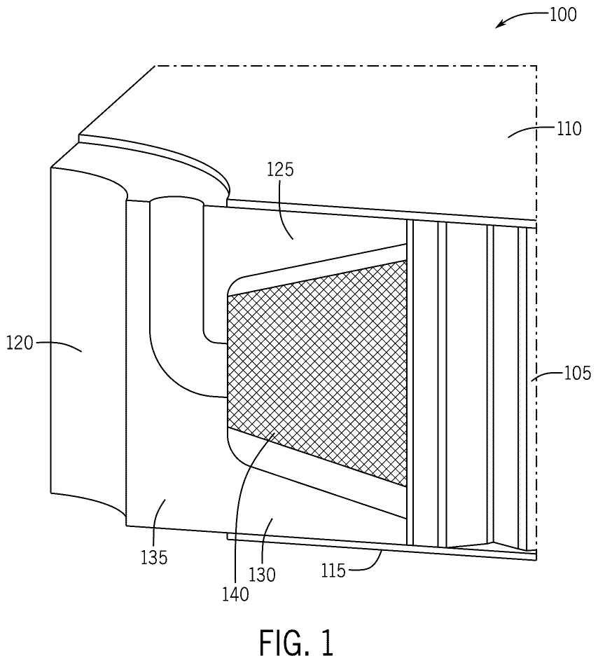

FIG. 1 shows an example of a panel 100 including an additively manufactured insert. In one example, the panel 100 may be a sandwich composite panel having a core 105 sandwiched between a first face sheet 110 and a second face sheet 115. In one example, the core may define a honeycomb lattice structure made from a metallic material (e.g., aluminum, etc.). Further, the face sheets may define a substantially flat sheet of carbon fiber or other polymeric or metallic material. As should be appreciated, in other examples, the panel 100 may be another form of composite material, such as pure laminate, cross-laminated timbers, or other thick-section members.

To increase the overall strength of the panel 100, the panel 100 may include an insert 120, which may be formed via an additive manufacturing process (e.g., 3D printed). In one example, the insert 120 may be made from a plastic material (e.g., a thermoplastic material). Further, the insert 120 may be integrated into the panel 100 prior to a curing process of the panel 100, which mitigates the need for additional machining operations on the panel 100 following the curing process.

The insert 120 may include a first flange 125 and a second flange 130 circumferentially extending from a central support column 135. In one example, the insert 120 may be arranged between the first face sheet 110 and the second face sheet 115, with the first face sheet 110 and the second face sheet 115 each overlapping a portion of a first flange 125 and a second flange 130 of the insert 120. Thus, the insert 120 may be integrated into the panel 100 so that the insert 120 may provide additional structural integrity to the panel 100 (e.g., increase overall stiffness, maximum force resistance, or total energy absorption). To further secure the insert 120 within the panel 100 (e.g., between the face sheets 110, 115), potting material 140 may be injected into the insert 120 via one or more openings (e.g., via an input opening). In one example, the potting material 140 may be injected through one or more integral J-shaped channels, which may deposit potting material into one or more chambers arranged circumferentially around the insert to permit the potting material 140 to engage the core 105 and secure the insert 120 within the panel 100.

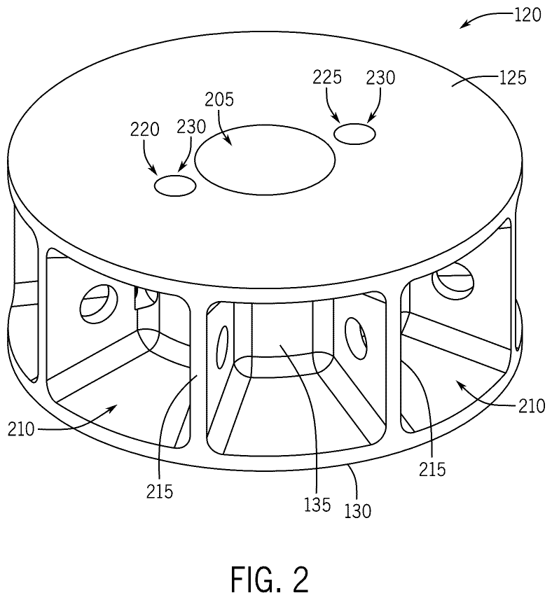

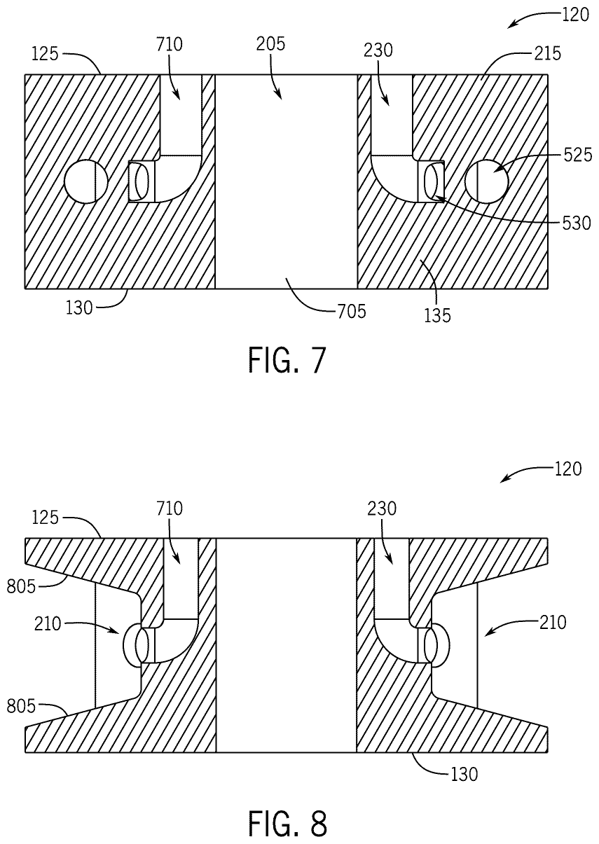

FIG. 2 illustrates an example of the insert 120, which may include a thru-hole 205 configured to receive a fastener (e.g., a bolt, screw, rivet, or any other known fastener) to secure the panel 100 to a desired location (e.g., structure, etc.) via the insert 120. In one example, the thru-hole 205 may include an interior surface 705 (see, e.g., FIG. 7), which may include threads. In another example, the interior surface 705 of the thru-hole 205 may not include threads and may instead be smooth. In other examples, the hole may not be a thru-hole and may instead be in the form of a blind hole (e.g., a threaded or non-threaded blind hole) or other hole type. In one example, the insert 120 may include a series of chambers 210 arranged circumferentially around the support column 135. The chambers 210 may be configured to receive potting material (e.g., an adhesive or epoxy) via one or more openings 230 to secure the insert 120 within the panel 100 (e.g., to the core 105). In one particular example, the insert 120 may include an input opening 220 on the first flange 125 to permit an operator to inject potting material into the chambers 210. Further, the insert 120 may include an output opening 225 on the insert 120 to permit an operator to determine when the potting material has filled each of the chambers 210. For example, an operator may determine that the potting material has filled each of the chambers 210 when the operator observes potting material at the output opening 225.

In one example, each of the chambers 210 may be defined by a series of walls 215 extending between the first flange 125 and the second flange 130. The walls 215 may provide additional structural strength to the insert 120 (e.g., to resist compressive forces applied to the insert). Further, as can be seen in FIG. 5, the walls 215 may each include an aperture 525 to permit the flow of potting material between adjacent chambers 210. Thus, each of the chambers 210 may be filled with potting material via a single opening 230.

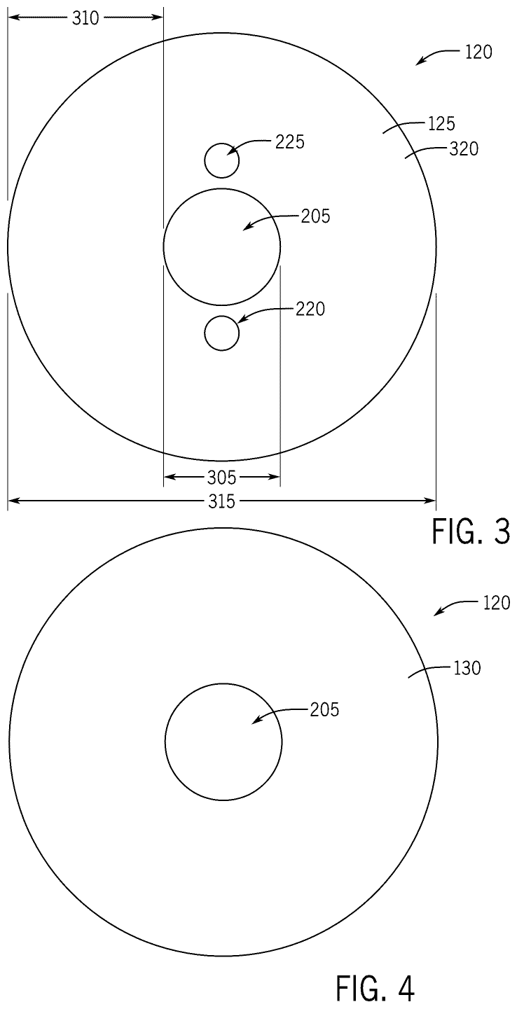

Turning to FIGS. 3 and 4, the first flange 125 and the second flange 130 may define substantially circular cross-sections each having a diameter 315. In one example, the diameter 315 of the first flange 125 and the second flange 130 may be substantially equal, with the support column 135 defining a smaller (e.g., dimensionally smaller) diameter. Further, the thru-hole 205 may be positioned at about a center of the first flange 125 and the second flange 130 and have a diameter 305 sized to receive a fastener. In one example, the diameter 305 of the thru-hole 205 and the diameter 315 of the insert 120 may be sized differently depending on the intended use case. For example, the diameter 315 and the diameter 305 may be larger for heavier duty applications and smaller for lighter duty application.

In one example, the first flange 125 and the second flange 130 may each include a surface 320 extending between the thru-hole 205 and the outer edge of the first flange 125 or second flange 130. The surface 320 may include a length 310 that is sized so that a portion of the first flange 125 and the second flange 130 may be sandwiched between the first face sheet 110 and the second face sheet 115 of the panel 100 (e.g., in contact or overlapping with the first face sheet 110 and the second face sheet 115). Thus, the insert 120 may be integrated into the panel 100, between the first face sheet 110 and the second face sheet 115. Additionally, the surface area of the first flange 125 and the second flange 130 overlapping with the first face sheet 110 and the second face sheet 115 may increase an overall strength of the panel 100.

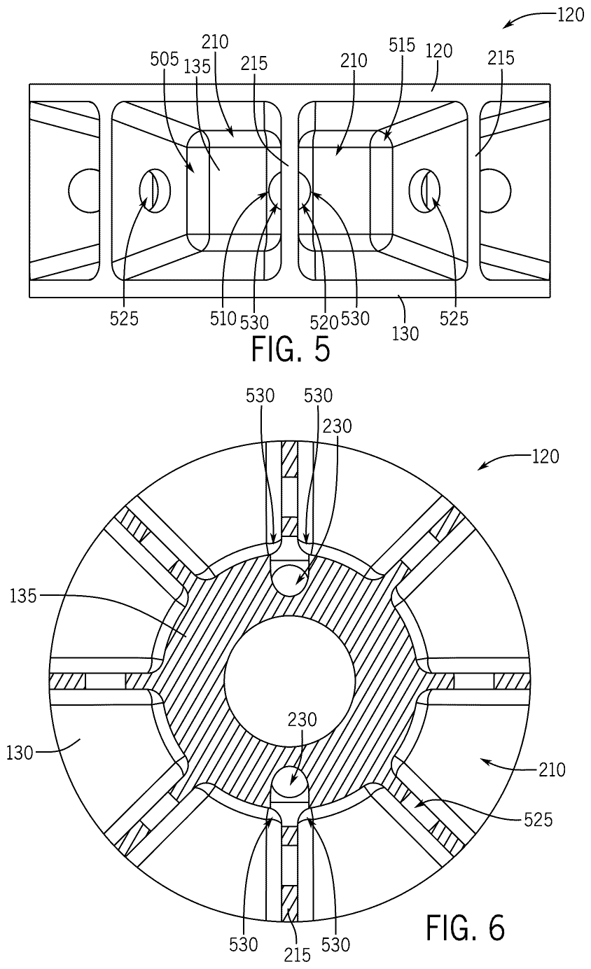

FIGS. 5-8 illustrate examples of the insert 120 including one or more integral channels 710. The channels 710 may be aligned with the input opening 220 and the output opening 225 to define an input channel for inputting potting material 140 into the chambers and an output channel for outputting potting material from the chambers to notify an operator that the chambers are full of potting material. In one example, the channels 710 may be substantially J-shaped to guide potting material into or out of the one or more chambers 210. In one example, the channels 710 may be formed during the manufacturing process of the insert 120 (e.g., via additive manufacturing) so that the need for additional machining of the insert 120 following a cure process of the panel 100 is mitigated.

In one example, the channels 710 (e.g., the input channel) may deposit potting material into the one or more chambers 210 via one or more openings 530. In one particular example, the openings 530 of the channels 710 may be aligned with an end of one of the walls 215 so that the openings 530 are separated into a first opening 510 and a second opening 520. Put differently, the end of one of the walls 215 may bisect the openings 530 into the first opening 510 and the second opening 520. Correspondingly, the channels 710 may permit flow of potting material into or out of more than one chamber 210 at the same time. In other examples, the walls 215 may be offset from the openings 530 of the channels 710 so that the openings 530 outputs to only a single chamber 210 rather than a pair of chambers 210 via a pair of openings.

For example, the input channel may deposit potting material into a first chamber 505 via the first opening 510 while also depositing potting material into a second chamber 515 via the second opening 520. Further, once the first chamber 505 and the second chamber 515 are filled with potting material, as further potting material is injected via the channel, the potting material may spread through adjacent chambers 210 via the aperture 525 arranged in each of the walls 215. As mentioned previously, once each of the chambers 210 are filled with potting material, the operator may observe potting material at the output opening 225.

To provide additional structural support to the panel 100, the chambers 210 of the insert 120 may include angled walls 805, which may provide for additional surface contact (e.g., a larger surface area) between the potting material 140 and the core 105 at an outlet of the chambers 210. Thus, the surface area of the potting material at an outlet of the chambers 210 (e.g., the potting material in direct contact with the core 105) may be increased, which increases the overall strength of the panel 100.

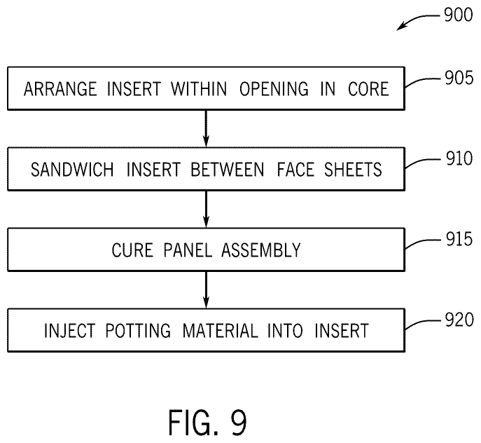

FIG. 9 shows an example of a manufacturing process 900 of the panel 100 utilizing the insert 120. At stage 905, the insert 120 may be arranged within an opening of the core 105. For example, an operator may drill or otherwise bore an opening in the core 105 that is sized to receive the insert 120. Following this, the operator may arrange (e.g., insert) the insert 120 into the opening (e.g., prior to applying the face sheets). At stage 910, the first face sheet 110 and the second face sheet 115 may be arranged on opposing sides of the core 105, with a portion of the first face sheet 110 and the second face sheet 115 overlapping a portion of the insert 120 (e.g., overlapping a portion of the first flange 125 and the second flange 130). Thus, at this stage, the insert 120 may be sandwiched between the first face sheet 110 and the second face sheet 115 adjacent the core 105. At stage 915, the panel 100 (e.g., including the core 105, first face sheet 110, second face sheet 115, and insert 120) may be cured to adhere the first face sheet 110 and the second face sheet 115 to the core 105 (and the insert 120 via the overlapping areas). In one example, the panel 100 may be cured in an oven or press to harden an adhesive and secure components of the panel 100 (e.g., the first face sheet 110 and the second face sheet 115) to the core 105 and the insert 120.

At stage 920, after the panel 100 has been cured, the insert 120 may be potted into the panel 100 via the injection of potting material into the chambers 210. For example, an operator may inject potting material (e.g., adhesive, epoxy, etc.) into the chambers 210 via the input channel (e.g., channel 710). In another example, the operator may inject potting material into the chambers 210 via the input opening 220 and may cease injecting potting material into the chambers 210 when the operator observes potting material at the output opening 225 of the insert 120 (e.g., indicating that each of the chambers 210 have been filled with potting material). As should be appreciated, the above manufacturing method may permit an operator to manufacture the panel 100 including the insert 120 without the need for any post-cure machining of the panel 100 or the insert 120.

In another example, as should be appreciated, the insert 120 may be utilized in a retrofit process (i.e., to replace another insert) or may be installed in a panel 100 using alternative manufacturing methods. For example, the panel 100 may be cured prior to installation of the insert 120. Following this, an opening may be drilled or otherwise bored through the panel 100 to receive the insert 120. The insert 120 may then be placed into the opening and secured within the opening as described above with respect to stage 920.

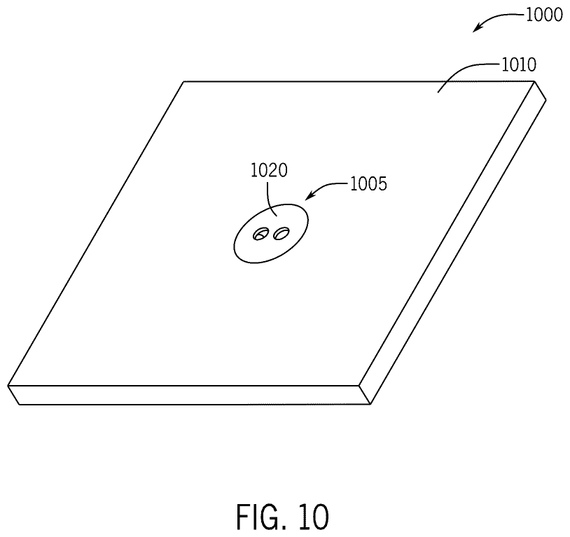

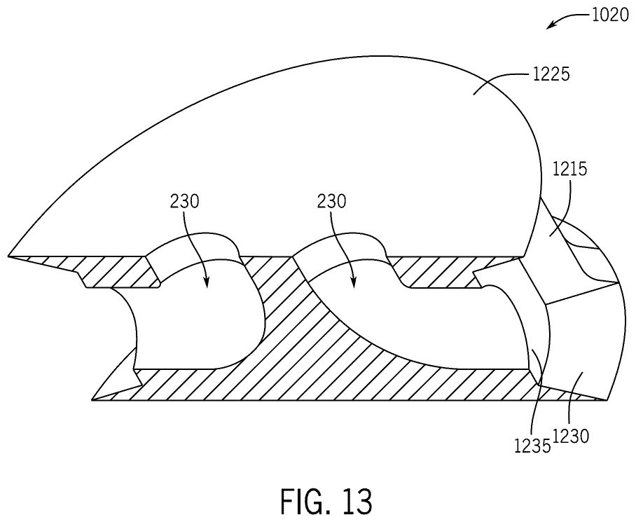

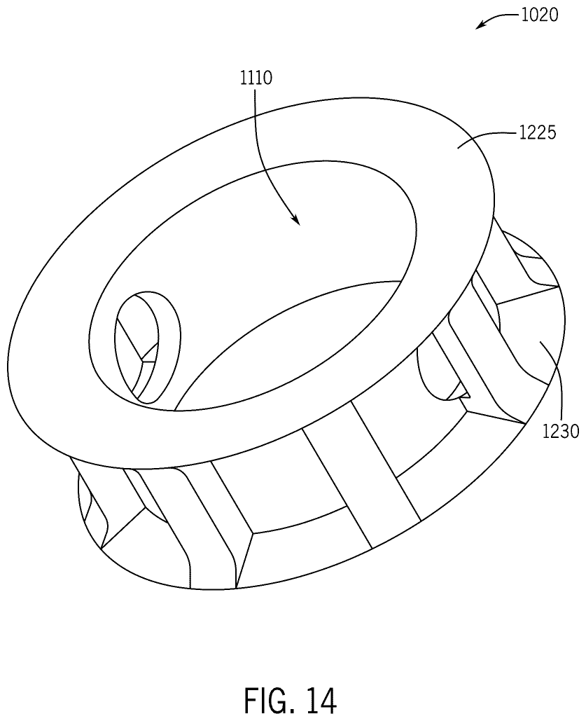

FIGS. 10-15 illustrate another example of a panel 1000 including an insert 1020. As will be recognized, the insert 1020 shares a number of components in common with and operates in a similar fashion to the examples illustrated and described previously (e.g., the insert 120). For the sake of brevity, these common features will not be again described below in detail. Rather, previous discussion of commonly named or numbered features, unless otherwise indicated, also applies to example configurations of the insert 1020.

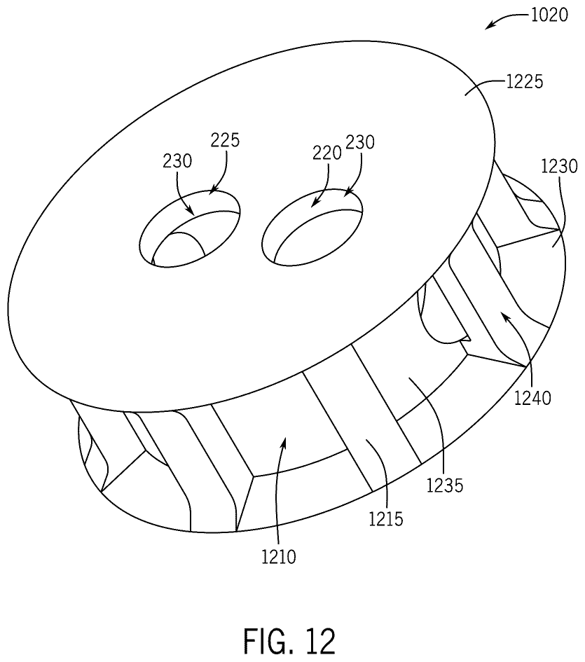

Looking at FIGS. 12-14 in particular, the insert 1020 may include a thru-hole 1110, which may be machined (e.g., drilled, etc.) through a first and second flange 1225, 1230 of the insert 1020 by a user. In some examples, the thru-hole 1110 may be a threaded thru-hole, a non-threaded thru-hole, a threaded blind hole, a non-threaded blind hole, or any other form of hole. In some examples, the user may drill the thru-hole 1110 to a desired diameter after a curing process of the panel 1000. In some examples, the thru-hole 1110 may be configured to receive a fastener (e.g., a bolt, screw, rivet, or any other known fastener) to secure the panel 1000 to a desired location (e.g., structure, etc.) via the insert 1020. In one example, the thru-hole 1110 may include an interior surface, which may include threads. In another example, the interior surface of the thru-hole 1110 may not include threads and may instead be smooth.

In one example, the insert 1020 may include a series of chambers 1210 arranged circumferentially around a support column 1235, which extends between the flanges 1225, 1230. The chambers 1210 may be configured to receive potting material (e.g., an adhesive or epoxy) via one or more openings 230 to secure the insert 1020 within the panel 1000. In one particular example, the insert 1020 may include an input opening 220 on the first flange 1225 to permit an operator to inject potting material into the chambers 210. Further, the insert 1020 may include an output opening 225 on the insert 1020 to permit an operator to determine when the potting material has filled each of the chambers 1210. For example, an operator may determine that the potting material has filled each of the chambers 1210 when the operator observes potting material at the output opening 225.

In one example, each of the chambers 1210 may be defined by a series of walls 1215 extending between the first flange 1225 and the second flange 1230. The walls 1215 may provide additional structural strength to the insert 1020 (e.g., to resist compressive forces applied to the insert). However, unlike the walls 215, the walls 1215 may not include an aperture and may instead be recessed (e.g., form a cutout 1240), so that potting material can flow between adjacent chambers 1210. Thus, each of the chambers 1210 may be filled (e.g., circumferentially via circumferential movement of potting material) with potting material via the opening 230.

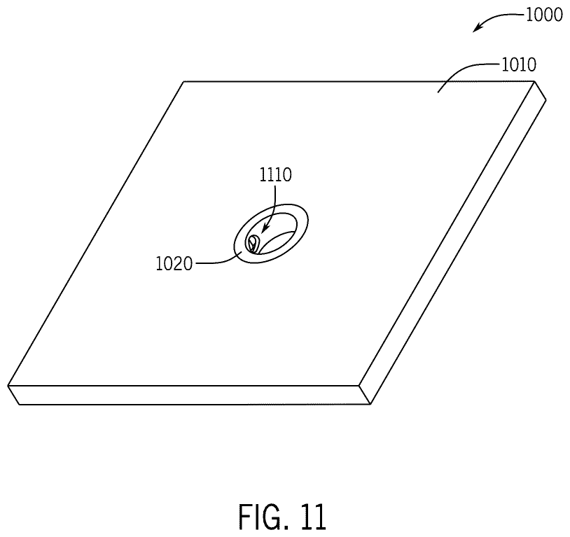

With reference to FIGS. 10 and 11, the insert 1020 (or the insert 120) may be arranged in the panel 1000 (e.g., a solid laminate panel 1010). In some examples, during manufacturing of the panel 1000, the insert 1020 may be positioned within a prepared hole 1005 before curing (e.g., in a pre-cured state). For example, the insert 1020 can be placed within the hole 1005 during the lay-up process of one or more laminate plies, with specific plies designed to overlap onto portions of the insert 1020 to create a mechanical interlock between the plies and the insert 1020.

In some examples, following this, the panel 1000 (e.g., including the insert 1020) may undergo a co-curing process where both a laminate resin system (of the panel) and an adhesive between the insert and surrounding panel are simultaneously cured. After curing, potting material can be injected into the insert 1020 to further secure the insert 1020 within the panel 1000. In some examples, the above-described approach may eliminate the need for post-cure drilling operations, which preserves continuous fiber reinforcement around the joint area, and creates a more uniform stress distribution between the fastening point and the laminate structure.

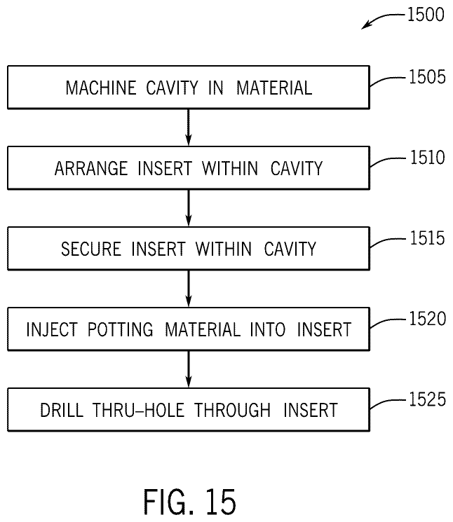

Turning to FIG. 15, a method of adding an insert to a panel following curing of the panel is shown. In some examples, a user may desire to add an insert (e.g., the insert 120 or the insert 1020) within the panel 1000 (e.g., a solid or sandwich laminate panel) following curing of the panel (e.g., in a post-curing stage). For example, at stage 1505, the user may machine (e.g., drill, etc.) the hole 1005 in the cured panel 1000. In some examples, the hole 1005 may be sized to receive and secure the insert 1020. Following this, at stage 1510, the insert 1020 may be arranged within the hole 1005. In some examples, the insert geometry is configured to mechanically interlock with the panel in order to minimize stress concentrations at an interface between the insert and the panel.

In some examples, at stage 1515, the insert 1020 may be secured within the hole 1005 via a structural adhesive. Following this, at stage 1520, the insert 1020 may be potted into the panel 1000 via the injection of potting material into the insert (e.g., via the chambers). For example, an operator may inject potting material (e.g., adhesive, epoxy, etc.) into the chambers via the input channel. In another example, the operator may inject potting material into the chambers via the input opening 220 and may cease injecting potting material into the chambers when the operator observes potting material at the output opening 225 of the insert 1020 (e.g., indicating that each of the chambers have been filled with potting material).

In some examples, at stage 1525, the thru-hole 1110 can then be drilled through the insert 1020 (e.g., to the size (diameter) desired by a user). In some examples, this post-cure machining approach provides flexibility in manufacturing processes and permits retrofit applications, while reducing the damage typically associated with conventional drilling and fastening methods.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within +12 degrees of a reference direction (e.g., within +6 degrees), inclusive. For a path that is not linear, the path can be considered to be substantially parallel to a reference direction if a straight line between endpoints of the path is substantially parallel to the reference direction or a mean derivative of the path within a common reference frame as the reference direction is substantially parallel to the reference direction.

Also as used herein, unless otherwise limited or defined, “substantially perpendicular” indicates a direction that is within +12 degrees of perpendicular a reference direction (e.g., within +6 degrees), inclusive. For a path that is not linear, the path can be considered to be substantially perpendicular to a reference direction if a straight line between endpoints of the path is substantially perpendicular to the reference direction or a mean derivative of the path within a common reference frame as the reference direction is substantially perpendicular to the reference direction.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of +15% or less, inclusive of the endpoints of the range. Similarly, the term “substantially equal” (and the like) as used herein with respect to a reference value refers to variations from the reference value of less than +10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. An insert for a composite material, the insert comprising:
a support column;
a first flange secured to a first end of the support column;
a second flange secured to a second, opposite end of the support column;
one or more chambers circumferentially arranged around the support column;
one or more walls extending from the first flange to the second flange, the one or more walls defining the one or more chambers; and
a channel extending from an input opening in the first flange to the one or more chambers, the channel to guide potting material from the input opening into the one or more chambers.

2. The insert of claim 1, wherein the insert is formed via an additive manufacturing process.

3. The insert of claim 1, wherein the first flange and the second flange are at least partially overlapped by respective first and second face sheets of a sandwich panel.

4. The insert of claim 1, wherein the one or more walls extend from the support column to an edge of the first flange and an edge of the second flange.

5. The insert of claim 2, wherein the channel is formed within the insert during the additive manufacturing process.

6. The insert of claim 3, wherein the insert is sandwiched between the first and second face sheets of the sandwich panel.

7. The insert of claim 1, wherein the one or more walls each define an aperture to permit potting material to flow between the one or more chambers.

8. A method of manufacturing a sandwich panel, the method comprising:
arranging an insert within an aperture of a core of a sandwich panel;
sandwiching the insert between a first face sheet of the sandwich panel and a second face sheet of the sandwich panel, the first face sheet arranged on a first side of the core and the second face sheet arranged on a second, opposite side of the core;
curing the sandwich panel after sandwiching the insert between the first face sheet and the second face sheet; and
injecting potting material into the insert after curing the sandwich panel.

9. The method of claim 8, wherein injecting the potting material into the insert includes injecting the potting material into one or more chambers of the insert via a J-shaped channel.

10. The method of claim 9, further comprising:
forming the insert via an additive manufacturing process.

11. The method of claim 10, further comprising:
forming the J-shaped channel within the insert during the additive manufacturing process.

12. The method of claim 9, wherein the one or more chambers are defined by one or more walls, and wherein at least a portion of the potting material injected into the insert flows between the one or more chambers via an aperture defined by each of the one or more walls.

13. The method of claim 8, further comprising:
sandwiching the insert between the first face sheet and the second face sheet so that the first face sheet partially overlaps a first flange of the insert, and the second face sheet partially overlaps a second flange of the insert.

14. An insert for a composite material, comprising:
a support column having a first end and a second end;
a first flange secured to the first end of the support column;
a second flange secured to the second end of the support column;
a plurality of chambers arranged circumferentially around the support column between the first flange and the second flange;
a plurality of walls extending from the support column, between the first flange and the second flange, to define the chambers; and
an input channel extending from an input opening in the first flange to at least one of the chambers, the input channel configured to guide potting material from the input opening into the chambers.

15. The insert of claim 14, wherein the insert is formed via an additive manufacturing process.

16. The insert of claim 14, wherein the first flange and the second flange are at least partially overlapped by respective first and second face sheets of a sandwich panel.

17. The insert of claim 14, wherein the walls each define an aperture to permit potting material to flow between the chambers.

18. The insert of claim 14, wherein the walls each define a cutout to permit potting material to flow between the chambers.

19. The insert of claim 14, further comprising:
a thru-hole extending through the first flange, the support column, and the second flange, the thru-hole to receive a fastener.

20. The insert of claim 14, further comprising:
an output channel extending from an output opening in the first flange to at least one of the chambers, the output channel configured to guide potting material from the chambers out of the output opening.
